(19) United States
(12) Patent Application Publication
(10) Pub. No.: US 2024/0074511 A1
(43) Pub. Date: Mar. 7, 2024

(54) AEROSOL PROVISION SYSTEM

(71) Applicant: Nicoventures Trading Limited, London (GB)

(72) Inventor: Patrick MOLONEY, London (GB)

(21) Appl. No.: 18/261,135

(22) PCT Filed: Dec. 7, 2021
(86) PCT No.: PCT/GB2021/053192

§ 371 Date: Jul. 12, 2023

(30) Foreign Application Priority Data
Jan. 14, 2021 (GB) 2100464.3

(51) Int. Cl. A24F 40/53; A24F 40/10; A24F 40/44; A24F 40/51; A24F 40/60; G01K 3/10

(52) U.S. Cl. CPC A24F 40/53; A24F 40/10; A24F 40/44; A24F 40/51; A24F 40/60; G01K 3/10

(57) ABSTRACT

An aerosol provision system can include an aerosolizable material transport element and a reservoir for aerosolizable material, wherein the aerosolizable material transport element can include a vaporizer for vaporizing aerosolizable material in the aerosolizable material transport element. The aerosol provision system can include control circuitry configured to monitor at least one temperature parameter relating to the temperature of the aerosolizable material transport element over a predetermined period of time after the vaporizer has been heated as part of a first heating operation. The control circuitry then generates a signal in the event the temperature parameter decreases by a predetermined amount in a predetermined time interval after the vaporizer has been heated. This signal may be indicative of a failure state of the aerosolizable material transport element 42.

### PRIORITY CLAIM

The present application is a National Phase entry of PCT Application No. PCT/GB2021/053192, filed Dec. 7, 2021, which claims priority from GB Application No. 2100464.3, filed Jan. 14, 2021, each of which is hereby fully incorporated herein by reference.

### TECHNICAL FIELD

The present disclosure relates to aerosol provision systems such as nicotine delivery systems (e.g. electronic cigarettes and the like).

### BACKGROUND

Electronic aerosol provision systems such as electronic cigarettes (e-cigarettes) generally contain an aerosol precursor material, such as a reservoir of a source liquid containing a formulation, typically including nicotine, or a solid material such a tobacco-based product, from which an aerosol is generated for inhalation by a user, for example through heat vaporization. Thus, an aerosol provision system will typically comprise a vaporizer, e.g. a heating element, arranged to vaporize a portion of precursor material to generate an aerosol in an aerosol generation region of an air channel through the aerosol provision system. As a user inhales on the device and electrical power is supplied to the vaporizer, air is drawn into the device through one or more inlet holes and along the air channel to the aerosol generation region, where the air mixes with the vaporized precursor material and forms a condensation aerosol. The air drawn through the aerosol generation region continues along the air channel to a mouthpiece opening, carrying some of the aerosol with it, and out through the mouthpiece opening for inhalation by the user.

It is common for aerosol provision systems to comprise a modular assembly, often having two main functional parts, namely a control unit and disposable/replaceable cartridge part. Typically the cartridge part will comprise the consumable aerosol precursor material and the vaporizer (atomizer), while the control unit part will comprise longer-life items, such as a rechargeable battery, device control circuitry, activation sensors and user interface features. The control unit may also be referred to as a reusable part or battery section and the replaceable cartridge may also be referred to as a disposable part or cartomizer.

The control unit and cartridge are mechanically coupled together at an interface for use, for example using a screw thread, bayonet, latched or friction fit fixing. When the aerosol precursor material in a cartridge has been exhausted, or the user wishes to switch to a different cartridge having a different aerosol precursor material, the cartridge may be removed from the control unit and a replacement cartridge may be attached to the device in its place.

A potential drawback for cartridges containing liquid aerosol precursor (e-liquid) is the risk of leakage. An e-cigarette cartridge will typically have a mechanism, e.g. a capillary wick, for drawing aerosolizable material from an aerosolizable material reservoir to a vaporizer located in an air path/channel connecting from an air inlet to an aerosol outlet for the cartridge. Because there is a fluid transport path from the aerosolizable material reservoir into the open air channel through the cartridge, there is a corresponding risk of aerosolizable material leaking from the cartridge. Leakage is undesirable both from the perspective of the end user naturally not wanting to get the e-liquid on their hands or other items, and also from a reliability perspective, since leakage from an end of the cartridge connected to the control unit may damage the control unit, for example due to corrosion. Some approaches to reduce the risk of leakage may involve restricting the flow of aerosolizable material to the vaporizer, for example by tightly clamping a wick where it enters the air channel. In normal use, the aerosolizable material taken up by the wick is sufficient to keep the vaporizer cool (i.e., at an ideal operating temperature), but when the aerosolizable material taken up is insufficient (e.g., when the aerosolizable material in the reservoir runs low) this can in some scenarios give rise to overheating and undesirable flavors.

Various approaches are therefore described herein which seek to help address or mitigate some of the issues discussed above.

### SUMMARY

According to a first aspect of certain embodiments there is provided an aerosol provision system comprising an aerosolizable material transport element and a reservoir for aerosolizable material, wherein the aerosolizable material transport element comprises a vaporizer for vaporizing aerosolizable material in the aerosolizable material transport element; wherein the aerosol provision system comprises control circuitry which is configured to monitor at least one temperature parameter relating to the temperature of the aerosolizable material transport element over a predetermined period of time after the vaporizer has been heated as part of a first heating operation, and generate a signal in the event the temperature parameter decreases by a predetermined amount in a predetermined time interval after the vaporizer has been heated, wherein the signal is indicative of a failure state of the aerosolizable material transport element.

According to a second aspect of certain embodiments there is provided a method of determining a failure state of an aerosolizable material transport element in an aerosol provision system comprising: control circuitry; a reservoir for aerosolizable material; and an aerosolizable material transport element, wherein the aerosolizable material transport element comprises a vaporizer for vaporising aerosolizable material in the aerosolizable material transport element; wherein the method comprises: monitoring, using the control circuitry, at least one temperature parameter relating to the temperature of the aerosolizable material transport element over a predetermined period of time after the vaporizer has been heated as part of a first heating operation; determining, using the control circuitry, whether the temperature parameter decreases by the predetermined amount in a predetermined time interval after the vaporizer has been heated; and generating a signal in the event the temperature parameter decreases by the predetermined amount in the predetermined time interval after the vaporizer has been heated, wherein the signal is indicative of the failure state of the aerosolizable material transport element.

It will be appreciated that features and aspects of the disclosure described above in relation to the various aspects of the disclosure are equally applicable to, and may be combined with, embodiments of the disclosure according to other aspects of the disclosure as appropriate, and not just in the specific combinations described herein.

### BRIEF DESCRIPTION OF THE DRAWINGS

Embodiments of the disclosure will now be described, by way of example only, with reference to the accompanying drawings, in which:

FIG. 1 schematically represents in perspective view an aerosol provision system comprising a cartridge and control unit (shown separated) in accordance with certain embodiments of the disclosure.

FIG. 2 schematically represents in exploded perspective view of components of the cartridge of the aerosol provision system of FIG. 1.

FIGS. 3A to 3C schematically represent various cross-section views of a housing part of the cartridge of the aerosol provision system of FIG. 1.

FIGS. 4A and 4B schematically represent a perspective view and a plan view of a dividing wall element of the cartridge of the aerosol provision system of FIG. 1.

FIGS. 5A to 5C schematically represent two perspective views and a plan view of a resilient plug of the cartridge of the aerosol provision system of FIG. 1.

FIGS. 6A and 6B schematically represent a perspective view and a plan view of a bottom cap of the cartridge of the aerosol provision system of FIG. 1.

FIG. 7 represents a schematic view of an aerosol provision system in accordance with certain embodiments of the disclosure.

FIG. 8 represents a plot of monitoring, in an aerosol provision system such as that shown in FIG. 7, a temperature parameter relating to the temperature of a wick (or its vaporizer) over a predetermined period of time after the vaporizer has been heated as part of a first heating operation, in accordance with certain embodiments of the disclosure.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems, which may also be referred to as aerosol provision systems, such as e-cigarettes. According to the present disclosure, a “non-combustible” aerosol provision system is one where a constituent aerosolizable material of the aerosol provision system (or component thereof) is not combusted or burned in order to facilitate delivery to a user. Aerosolizable material, which also may be referred to herein as aerosol generating material or aerosol precursor material, is material that is capable of generating aerosol, for example when heated, irradiated or energized in any other way.

Throughout the following description the term “e-cigarette” or “electronic cigarette” may sometimes be used, but it will be appreciated this term may be used interchangeably with aerosol provision system/device and electronic aerosol provision system/device. An electronic cigarette may also known as a vaping device or electronic nicotine delivery system (END), although it is noted that the presence of nicotine in the aerosolizable material is not a requirement.

In some embodiments, the non-combustible aerosol provision system is a hybrid system to generate aerosol using a combination of aerosolizable materials, one or a plurality of which may be heated. In some embodiments, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the article for use with the non-combustible aerosol provision device may comprise an aerosolizable material (or aerosol precursor material), an aerosol generating component (or vaporizer), an aerosol generating area, a mouthpiece, and/or an area for receiving aerosolizable material.

In some embodiments, the aerosol generating component is a heater capable of interacting with the aerosolizable material so as to release one or more volatiles from the aerosolizable material to form an aerosol. In some embodiments, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In some embodiments, the substance to be delivered may be an aerosolizable material which may comprise an active constituent, a carrier constituent and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, and/or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

As noted above, aerosol provision systems (e-cigarettes) often comprise a modular assembly including both a reusable part (control unit) and a replaceable (disposable) cartridge part. Devices conforming to this type of two-part modular configuration may generally be referred to as two-part devices. It is also common for electronic cigarettes to have a generally elongate shape. For the sake of providing a concrete example, certain embodiments of the disclosure described herein comprise this kind of generally elongate two-part device employing disposable cartridges. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

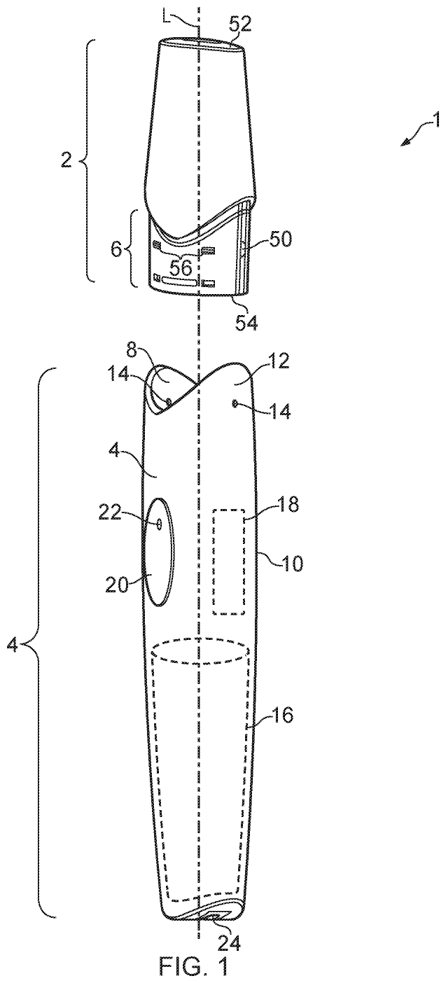

FIG. 1 is a schematic perspective view of an example aerosol provision system/device (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 comprises two main components, namely a cartridge 2 and a control unit 4. The control unit 4 and the cartridge 2 are shown separated in FIG. 1, but are coupled together when in use.

The cartridge 2 and control unit 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece end 52 and an interface end 54 and is coupled to the control unit by inserting an interface end portion 6 at the interface end of the cartridge into a corresponding receptacle 8/cartridge receiving section of the control unit. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the control unit. An electrical connection is established between the control unit and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a control unit at all, for example because the transfer of electrical power from the reusable part to the cartridge may be wireless (e.g. based on electromagnetic induction techniques).

The electronic cigarette 1 has a generally elongate shape extending along a longitudinal axis L. When the cartridge is coupled to the control unit, the overall length of the electronic cigarette in this example (along the longitudinal axis) is around 12.5 cm. The overall length of the control unit is around 9 cm and the overall length of the cartridge is around 5 cm (i.e. there is around 1.5 cm of overlap between the interface end portion 6 of the cartridge and the receptacle 8 of the control unit when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The control unit 4 may in accordance with certain embodiments of the disclosure be broadly conventional in terms of its functionality and general construction techniques. In the example of FIG. 1, the control unit 4 comprises a plastic outer housing 10 including the receptacle wall 12 that defines the receptacle 8 for receiving the end of the cartridge as noted above. The outer housing 10 of the control unit 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the control unit in two different orientations. The receptacle wall 12 includes two control unit air inlet openings 14 (i.e. holes in the wall). These openings 14 are positioned to align with an air inlet 50 for the cartridge when the cartridge is coupled to the control unit. A different one of the openings 14 aligns with the air inlet 50 of the cartridge in the different orientations. It will be appreciated some implementations may not have any degree of rotational symmetry such that the cartridge is couplable to the control unit in only one orientation while other implementations may have a higher degree of rotational symmetry such that the cartridge is couplable to the control unit in more orientations.

The control unit further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colors and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

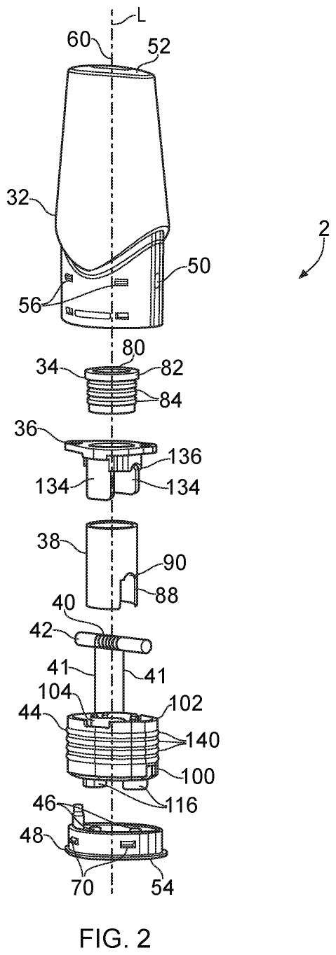

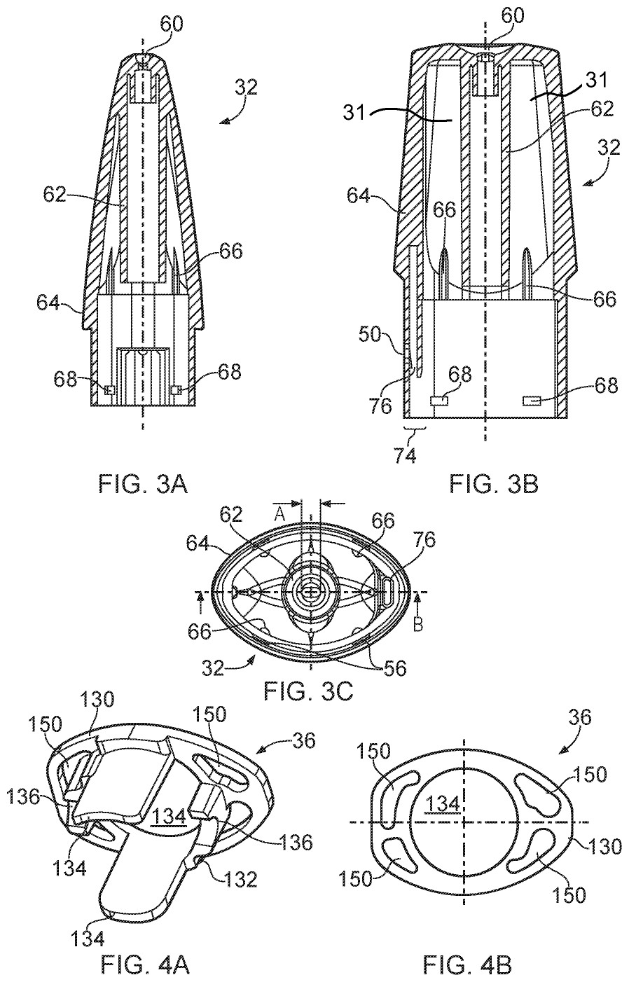

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporizer/heating element 40, an aerosolizable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

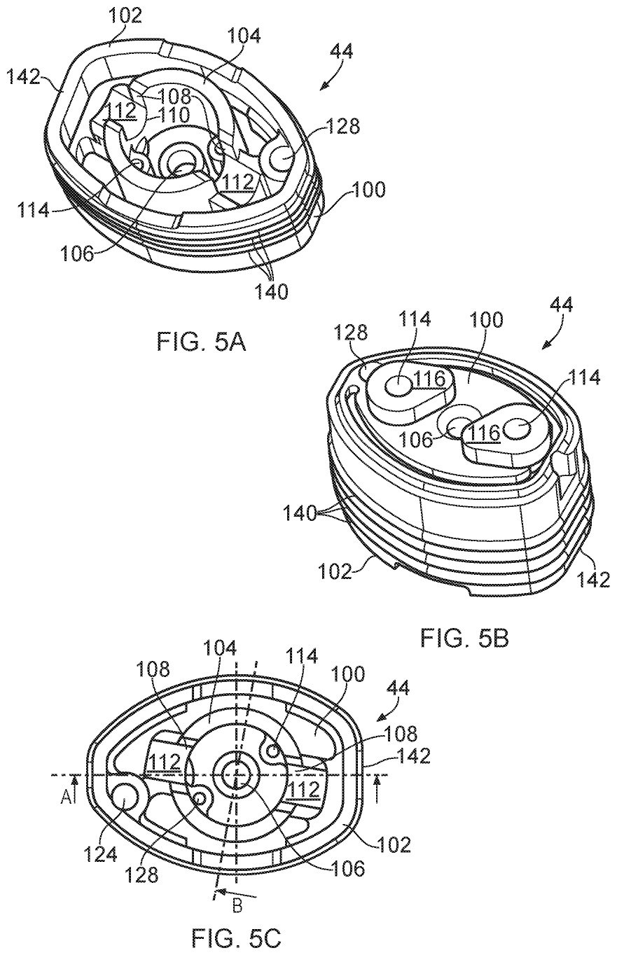

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

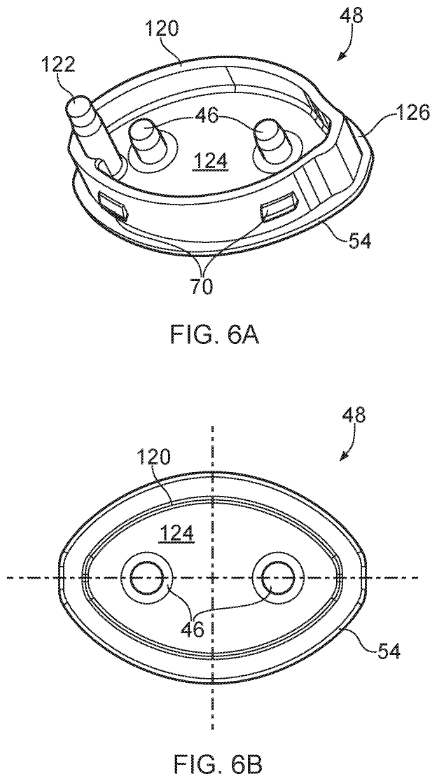

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single molding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60 in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the control unit. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone molding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section of ANSI 304 stainless steel with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolizable material transport element 42 comprises a capillary wick and the vaporizer 40 comprises a resistance wire heater wound around the capillary wick. In addition to the portion of the resistance wire wound around the capillary wick, the vaporizer comprises electrical leads 41 which pass through holes in the plug 44 to contact electrodes 46 mounted to the end cap 54 to allow power to be supplied to the vaporizer via the electrical interface the established when the cartridge is connected to a control unit. The vaporizer leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fiber bundle. The vaporizer and aerosolizable material transport element may be provided in accordance with any conventional techniques and may comprise different forms and/or different materials. For example, in some implementations the wick may comprise a fibrous or solid ceramic material and the heater may comprise a different alloy. In other examples the heater and wick may be combined, for example in the form of a porous and a resistive material. More generally, it will be appreciated the specific nature aerosolizable material transport element and vaporizer is not of primary significance to the principles described herein. When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single molding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolizable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolizable material transport element passes. The size of the holes provided by the semi-circular recesses through which the aerosolizable material transport element passes correspond closely to the size and shape of the aerosolizable material transport element, but are slightly smaller so a degree of compression is provided by the resilience of the plug 44. This allows aerosolizable material to be transported along the aerosolizable material transport element by capillary action while restricting the extent to which aerosolizable material which is not transported by capillary action can pass through the openings. As noted above, the plug 44 includes further openings 114 in the base part 100 through which the contact leads 41 for the vaporizer pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporizer pass.

The end cap 48 comprises a polypropylene molding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the control unit connect when the cartridge is assembled and connected to the control unit. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporizer by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single molding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolizable material transport element passes.

When the cartridge is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporizer 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60. The air channel from the aerosol generation region to be the aerosol outlet may be referred to as an aerosol outlet section of the air channel.

Also, when the cartridge is assembled a reservoir 31 for aerosolizable material is formed by the space outside the air channel and inside the housing part 32. This may be filled during manufacture, for example through a filling hole which is then sealed, or by other means. The specific nature of the aerosolizable material, for example in terms of its composition, is not of primary significance to the principles described herein, and in general any conventional aerosolizable material of the type normally used in electronic cigarettes may be used. The present disclosure may refer to a liquid as the aerosolizable material, which as mentioned above may be a conventional e-liquid. However, the principles of the present disclosure apply to any aerosolizable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolizable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolizable material transport element extend into the second region of the reservoir from which they draw aerosolizable material through the openings in the air channel to the vaporizer 40 for subsequent vaporization.

In normal use, the cartridge 2 is coupled to the control unit 4 and the control unit activated to supply power to the cartridge via the contact electrodes 46 in the end cap 48. Power then passes through the connection leads 41 to the vaporizer 40. The vaporizer is thus electrically heated and so vaporizes a portion of the aerosolizable material from the aerosolizable material transport element in the vicinity of the vaporizer. This generates aerosol in the aerosol generation region of the air path. Aerosolizable material that is vaporized from the aerosolizable material transport element is replaced by more aerosolizable material drawn from the reservoir by capillary action. While the vaporizer is activated, a user inhales on the mouthpiece end 52 of the cartridge. This causes air to be drawn through whichever control unit air inlet 14 aligns with the air inlet 50 of the cartridge (which will depend on the orientation in which the cartridge was inserted into the control unit receptacle 8). Air then enters the cartridge through the air inlet 50, passes along the gap 76 in the double-walled section 74 of the housing part 32, passes between the plug 44 and the end cap 48 before entering the aerosol generation region surrounding the vaporizer 40 through the hole 106 in the base part 100 of the plug 44. The incoming air mixes with aerosol generated from the vaporizer to form a condensation aerosol, which is then drawn along the outlet tube 38 and the housing part inner 62 before exiting through the mouthpiece outlet/aerosol outlet 60 for user inhalation.

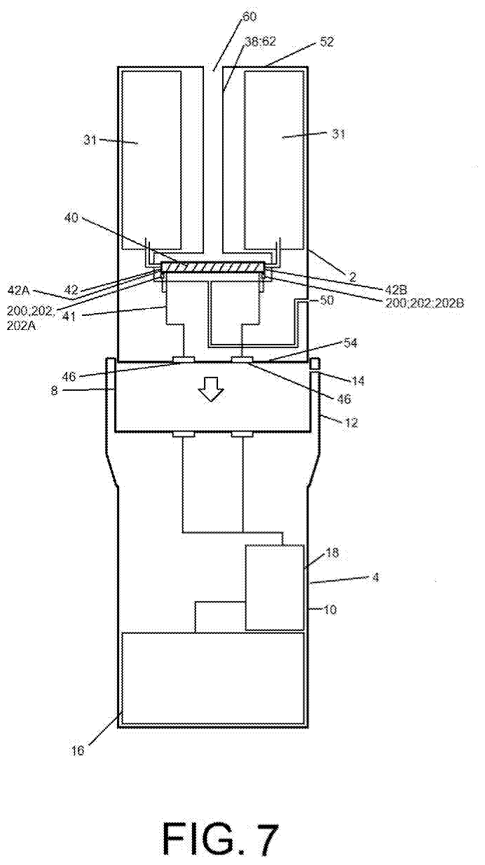

With reference to FIG. 7, there is shown schematically a cross section view of a modified cartridge 2 for use with a control unit 4 to form an aerosol provision system 1 in accordance with certain embodiments of the disclosure. The aerosol provision system 1; cartridge 2; and control unit 4 shown in FIG. 7 is based on the construction of the corresponding aerosol provision system 1; cartridge 2; and control unit 4; shown in FIGS. 1-6B, and comprise similar components as set out by the reference numerals that are common to both sets of Figures. For instance, the cartridge 2 defines a reservoir 31 which extends around an aerosol outlet tube 38. In accordance with such embodiments, the reservoir 31 may be annular, and is configured for containing aerosolizable material for aerosolizing. Similarly, the control unit 4 may comprise the plastic outer housing 10 including the receptacle wall 12 that defines the receptacle 8 for receiving the end of the cartridge 2. The control unit 4 may also comprise the control circuitry 18 and the power supply/battery 16.

Noting the above, and with initial reference to the aerosol provision system 1 shown in FIG. 7, a first modification over the aerosol provision system shown 1 in FIGS. 1-6B is the introduction of a configuration to measure at least one parameter of the aerosolizable material transport element (wick) 42 to determine a status of the aerosolizable material transport element. In essence therefore, and at a broad level, FIG. 7 illustrates an aerosol provision system 1 comprising a reservoir 31 for aerosolizable material; an aerosolizable material transport element/wick 42 configured to receive the aerosolizable material from the reservoir 31, a vaporizer 40, forming part of the aerosolizable material transport element 42, configured to vaporize the aerosolizable material received in the aerosolizable material transport element 42, wherein the aerosol provision system 1 is configured to monitor at least one temperature parameter relating to the temperature of the aerosolizable material transport element (or the temperature of its vaporizer 40) to determine a failure state of the aerosolizable material transport element 42.

In principal, the failure state of the aerosolizable material transport element 42 (or wick 42) could relate to a variety of different failure states for the aerosolizable material transport element/wick 42. However, in accordance with some particular embodiments, the status may be the aerosolizable material transport element containing 42 less than a predetermined amount of aerosolizable material, and/or the aerosolizable material transport element 42 (or its vaporizer 40) exceeding a predetermined temperature. Both these may therefore correspond to a dry-out status of the aerosolizable material transport element 42, whereby the aerosolizable material transport element 42 is not saturated with aerosolizable material. During such dry-out conditions, as the vaporizer 40 from the aerosolizable material transport element 42 is operated, this may cause the aerosolizable material transport element 42 to become excessively hot, as a result of the heat generated by the vaporizer 40, and as result of there not being sufficient aerosolizable material to help cool the temperature of the aerosolizable material transport element 42.

In such a failure state, in so far as the aerosol provision system 1 may be configured to monitor at least one temperature parameter relating to the temperature of the aerosolizable material transport element to determine the failure state of the aerosolizable material transport element 42, this may allow the aerosol provision system 1 to react in such instances where a failure (dry-out) status is detected, as will be described.

Appreciating the foregoing, and in accordance with some embodiments, the aerosol provision system 1 may be provided with the control circuitry 18. In such embodiments, the control circuitry 18 may be configured to monitor at least one temperature parameter relating to the temperature of the aerosolizable material transport element 42 over a predetermined period of time after the vaporizer 40 has been heated as part of a first heating operation, and generate a signal in the event the temperature parameter decreases by a predetermined amount in a predetermined time interval after the vaporizer 40 has been heated. In the event such a signal is generated, the signal may be then indicative of a failure state of the aerosolizable material transport element 42. In this respect, and put differently, if the temperature parameter decreases by less than an predetermined (or expected) amount in the predetermined time interval, this may be indicative of a failure (dry-out state) of the aerosolizable material transport element 42, such as due to the aerosolizable material transport element not cooling down quick enough as a result of there not being sufficient aerosolizable material in the aerosolizable material transport element 42 to help cool the temperature of the aerosolizable material transport element 42.

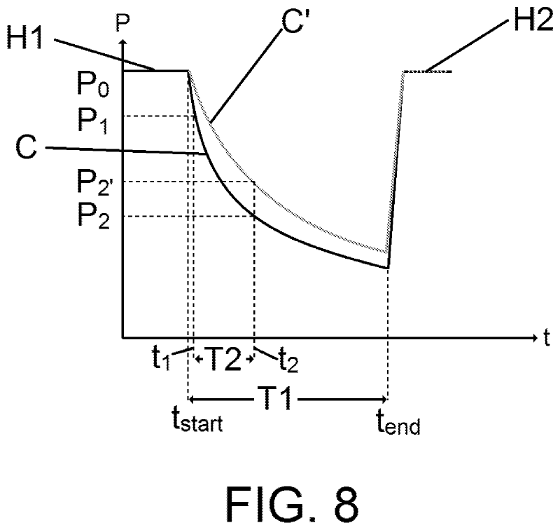

With the above in mind therefore, and turning to FIG. 8, there is shown an embodiment of monitoring a temperature parameter P relating to the temperature of the aerosolizable material transport element 42 over a period of time T1 after the vaporizer 40 has been heated as part of a first heating operation H1. In that respect, FIG. 8 illustrates a plot of the temperature parameter ‘P’ over time ‘t’. In this plot, there is shown two varying profiles of the temperature parameter varying across a first heating operation H1, during a period of time T1 after the first heating operation H1, and finally varying during a second heating operation H2 occurring after the period of time T1 finishes.

In accordance with some embodiments, during the period of time T1 between the first heating operation H1 and the second heating operation H1, the vaporizer 40 may either not be powered, or provided with minimal power (i.e. less power than when the vaporizer is subject 40 to a heating operation H1;H2).

The temperature parameter P may take a number of different forms, however the overriding purpose of the temperature parameter is to provide an indication as to the temperature of the aerosolizable material transport element 42 (and/or its vaporizer 40). In that respect, if this temperature parameter P is uncharacteristically high in a given point or period of time, as outlined above, this may be indicative of a failure (dry-out state) of the aerosolizable material transport element 42, such as due to the aerosolizable material transport element not cooling down quick enough as a result of there not being sufficient aerosolizable material in the aerosolizable material transport element 42 to help cool the temperature of the aerosolizable material transport element 42.

Appreciating the foregoing therefore, in accordance with some embodiments, the aerosol provision system 1 may comprise at least one sensor 200 for outputting a first signal containing first data related to the temperature of the aerosolizable material transport element 42. In some particular embodiments, such as that shown in FIG. 7, the sensor 200 might be a temperature sensor 202, such as but not limited to a thermometer; an infrared sensor; or an optical sensor, to output a first signal containing first data related to the temperature of the aerosolizable material transport element 42. Irrespective of any particular type of sensor 200 used, in accordance with these embodiments, the control circuitry 18 may be further configured to receive the first signal from the at least one sensor 200;202, and process the first data from the first signal to determine the at least one temperature parameter P.

In accordance with some embodiments, the aerosol provision system 1 may comprise a temperature sensor 200 comprising a resistor, wherein the resistor is configured to output a resistance value related to the temperature of the aerosolizable material transport element 42. In accordance with such embodiments, the control circuitry 18 may be then configured to measure the resistance value of the resistor 200, and process the resistance value to determine the at least one temperature parameter P.

To help simplify the electrical setup where any temperature sensor 200;202 is provided, in accordance with some particular embodiments thereof, the temperature sensor 200;202 may be located in series with the vaporizer 40. In this way, a single electrical circuit may be used to both operate the temperature sensor 200;202 and power the vaporizer 40 (such as by the power from the power supply 16).

For the sake of completeness, it is to be noted that where a sensor(s) 200 is employed, in accordance with some particular embodiments, more than one sensor 200 may be employed as required. In that respect for instance, in accordance with some particular embodiments such as the particular embodiment of FIG. 7, a first temperature sensor 202A and second temperature sensor may be employed 202B. In accordance with some of these embodiments, the first temperature sensor 202A may be located in a position that is more proximal a first end 42A of the aerosolizable material transport element 42, with the second temperature sensor 202B located in a position that is more proximal a second end 42B of the aerosolizable material transport element 42 (which, in some very particular embodiments therefrom, such as the embodiment of FIG. 7, may be opposite the first end 42A of the aerosolizable material transport element 42). Similarly, where a temperature sensor 202 is employed, it will be appreciated that the temperature sensor 202 may be either a contact sensor and/or a non-contact sensor, as required. For instance, in some very particular embodiments, the first temperature sensor(s) 202 may be located on a surface of the aerosolizable material transport element 42. In this way, the temperature sensor 202 may be better secured to the aerosolizable material transport element 42, and may allow the temperature sensor 202 to provide a more accurate resistance value or first signal related to the temperature of the aerosolizable material transport element 42.

It is to be also noted that in accordance with some embodiments of the aerosol provision system 1 herein described, there may not be need for a temperature sensor 202 at all. In that respect for instance, in embodiments where the temperature parameter P is related to the temperature of the vaporizer 40 of the aerosolizable material transport element 42, in some embodiments thereof, the control circuitry 18 may be configured to monitor the electrical resistance of the vaporizer 40 itself to determine an electrical resistance value of the vaporizer 40, and process the electrical resistance value to determine the at least one temperature parameter. In such embodiments, it can be seen that the need for a separate temperature sensor 202 in the aerosol provision system 1 may be dispensed with.

Thus appreciating the foregoing, it will be appreciated that the aerosol provision systems 1 herein described may employ a wide variety of different mechanisms for monitoring the at least one temperature parameter P relating to the temperature of the aerosolizable material transport element/wick 42 (or relating to the temperature of its vaporizer 40), over a predetermined period of time.

That being the case therefore, and returning to the disclosure of FIG. 8, the control circuitry 18 as noted previously may be configured to monitor the at least one temperature parameter P relating to the temperature of the aerosolizable material transport element 42 over a predetermined period of time after the vaporizer has been heated as part of a first heating operation. In accordance with some embodiments, such as that shown in the embodiment of FIG. 8, the predetermined period of time may end before the start of the second heating operation H2 of the vaporizer 40 occurring after the first heating operation H1 of the vaporizer 40. In this way, the monitoring of the temperature parameter P may be performed in the time period T1 whilst the aerosolizable material transport element 42 (and its vaporizer 40) is cooling down after the first heating operation H1. In this way, where the temperature parameter P falls at a normal, expected, rate during this period T1, this may be indicative of a correctly working aerosol provision system 1, such as an aerosolizable material transport element 42 that is supplied with a sufficient aerosolizable material in the aerosolizable material transport element 42 to help cool the temperature of the aerosolizable material transport element 42. This variation of the temperature parameter P in the time period T1 is indicated by the cooling curve C.

In contrast, where the temperature parameter P falls at a slower rate during this period T1, this may be indicative of a faulty aerosol provision system 1, such as an aerosolizable material transport element 42 that is supplied with an insufficient aerosolizable material in the aerosolizable material transport element 42 to help cool the temperature of the aerosolizable material transport element 42. This variation of the temperature parameter P in the time period T2 is indicated by the cooling curve C′.

Mindful of the above, in so far as the temperature parameter P decreases by a predetermined amount in a predetermined time interval T2 after the vaporizer 40 has been heated, or in more specific embodiments (such as that shown in FIG. 8 specifically) decreases by less than a predetermined amount (e.g. the difference between P2 and P1 in the case of the particular embodiment from FIG. 8) in the predetermined time interval T2, this may be indicative of an abnormal operation of the aerosol provision system 1, i.e. such as a failure state of the aerosolizable material transport element 42.

With reference to FIG. 8, it will be appreciated that in some embodiments, the at least one of the predetermined period of time (tₛₜₐᵣₜ−t_{end}), in which the control circuitry 18 monitors the at least one temperature parameter P, may be different from, or more than, the predetermined time interval T2. Appreciably however, in some other embodiments, the predetermined period of time (tₛₜₐᵣₜ−t_{end}) may be the same as the predetermined time interval T2. In that respect as well, whilst the predetermined period of time (tₛₜₐᵣₜ−t_{end}) is shown in the embodiment of FIG. 8 as corresponding to the period T1 between the end of the first heating operation H1 and the start of the second heating operation H2, in some embodiments the predetermined period of time (tₛₜₐᵣₜ−t_{end}) may be different to, such as less than, the time period T1 between the end of the first heating operation H1 and the start of the second heating operation H2.

In terms of the duration of the at least one of the predetermined period of time a (tₛₜₐᵣₜ−t_{end}) and/or the predetermined time interval T2, in accordance with some embodiments, this duration may be short enough in some embodiments to allow for a quicker determination of a failure state of the aerosolizable material transport element 42. In that respect therefore, and in accordance with some embodiments, at least one of the predetermined period of time, and the predetermined time interval, may be no more than: two seconds; 1.8 seconds; 1.5 seconds; 1.2 seconds; 1 second; 0.8 seconds; and 0.5 seconds.

Also in respect of the timing of the at least one of the predetermined period of time (tₛₜₐᵣₜ−t_{end}), and/or the predetermined time interval T2, in accordance with some embodiments, at least one of the predetermined period of time (tₛₜₐᵣₜ−t_{end}), and the predetermined time interval T2, may begin soon after the end of the first heating operation H1. This is because, as shown in FIG. 8, greater temperature reduction rates may be exhibited by the aerosolizable material transport element 42 (or its vaporizer 40) towards the start of the period T1 between the first heating operation H1 and the second heating operation H2, compared with towards the end of the period T1. In that way therefore, having the at least one of the predetermined period of time, and the predetermined time interval, begin soon after the end of the first heating operation H1 may allow for more reliable/accurate determinations of a failure state, due to a bigger variation of the temperature parameter P in this time region compared with a time region closer towards the end of the second heating operation H2. Accordingly, in some particular embodiments, at least one of the predetermined period of time, and the predetermined time interval, may begin no more than 0.5 seconds; 0.3 seconds; or 0.1 seconds after the vaporizer 40 has been heated as part of (i.e. at the end of) the first heating operation H1. Additionally/alternatively, in accordance some embodiments, the at least one of the predetermined period of time, and the predetermined time interval, may begin closer to the end of the first heating operation H1 than the start of the second heating operation H2.

Staying with the predetermined time interval T2, in accordance with some embodiments, the predetermined time interval T2 may be configured to commence at least, or no earlier than, 0.05 seconds after the end of the first heating operation H1 of the vaporizer 40. In that respect, in so far as the predetermined time interval T2 may be initiated too early, or just after the end of the end of the first heating operation H1 of the vaporizer 40, the value of the temperature parameter P in this initial period may be unwantedly affected by actions still occurring in/around from the aerosolizable material transport element 42 from the first heating operation H1, such as fluctuating/erratic cooling actions caused by residual vapour/airflow in and around the aerosolizable material transport element 42 from the previous heating operation H1. That being the case, in accordance with some embodiments therefore, the predetermined time interval T2 may be configured to commence at least, or no earlier than, 0.08 seconds, or 0.1 seconds, after the end of the first heating operation H1 of the vaporizer 40. That being said, there is inherently an advantage in some embodiments to not unduly delay the start of the predetermined time interval T2 by too much, for the reasons explained above. Such embodiments are illustrated with reference to the embodiment of FIG. 8, where the predetermined time interval T2 is seen to start (at time t₁) a short time after the end of the heating operation H1.

For the sake of completeness, in terms of the exact empirical amount of the temperature parameter P during any particular time/operation of the aerosol provision system 1, it will be appreciated that these empirical amounts will be set for each particular aerosol provision system 1 in advance, and will be further dependent on the sensing mechanism used in respect of the temperature parameter P as described previously. In that respect however, it will be apparent that the value of the temperature parameter P2 at the end of the predetermined time interval T2 in the case of the cooling curve C may be less than, and/or relate to a temperature of the aerosolizable material transport element 42 which is less than, the value of the temperature parameter P2′ at the end of the predetermined time interval T2 in the case of the cooling curve C′. In that respect as well, the value of the temperature parameter P2;P2′ at the end of the predetermined time interval T2 (at time t₂ from FIG. 8) may be appreciably less than the value of the temperature parameter P1 at the start of the predetermined time interval T2 (at time t₁ from FIG. 8), and less than the value of the temperature parameter P0 at the end of the first heating operation H1 (at time tsar from FIG. 8).

Thus described above is a variety of different mechanisms whereby the control circuitry 18 from the aerosol provision system 1 may monitor at least one temperature parameter P relating to the temperature of the aerosolizable material transport element 42 over a predetermined period of time after the vaporizer 40 has been heated as part of a first heating operation H1, and generate a signal in the event the temperature parameter P decreases by a predetermined amount in a predetermined time interval T2 after the vaporizer has been heated, wherein the signal is indicative of a failure state of the aerosolizable material transport element 42.

Also described is a corresponding method for carrying out the same, such as a method of determining a failure state of an aerosolizable material transport element 42 in an aerosol provision system 1 comprising: control circuitry 18; a reservoir 31 for aerosolizable material; and a aerosolizable material transport element 42, wherein the aerosolizable material transport element 42 comprises a vaporizer 40 for vaporizing aerosolizable material in the aerosolizable material transport element 42; and wherein the method comprises: monitoring, using the control circuitry 18, at least one temperature parameter P relating to the temperature of the aerosolizable material transport element 42 over a predetermined period of time after the vaporizer 40 has been heated as part of a first heating operation H1; determining, using the control circuitry 18, whether the temperature parameter P decreases by a predetermined amount (such as less than a predetermined amount, in some particular embodiments) in a predetermined time interval T2 after the vaporizer has been heated; and generating a signal in the event the temperature parameter P decreases by the predetermined amount P in the predetermined time interval T2 after the vaporizer 40 has been heated, wherein the signal is indicative of the failure state of the aerosolizable material transport element 42.

Where such a signal is generated, which may be indicative of a failure (such as a dry-out) state of the aerosolizable material transport element 42, in accordance with some embodiments, the signal may comprise a command to disable the operation of the aerosol provision system 1 and/or a command to disable the operation of the vaporizer 40. In some particular embodiments thereof, the control circuitry 18 may be then configured to disable the operation of the aerosol provision system 1 and/or the vaporizer 40 until the control circuitry 18 determines the temperature parameter P as falling beneath a predetermined amount (which may indicative of the temperature of the aerosolizable material transport element, or its vaporizer 40 in some particular embodiments, as having sufficiently cooled down). In embodiments where the aerosol provision system employs the cartridge 2 and the control unit 4, in accordance with some embodiments thereof, the control circuitry 18 may configured to disable the operation of the aerosol provision system 1 until the control circuitry 18 determines that a different cartridge 2 has been coupled to the control unit 4.

In accordance with some embodiments, the signal may comprise a command to provide a notification to a user. In accordance with some embodiments thereof, the control signal may comprise at least one of: an optical signal, an acoustic signal, and a haptic signal, which can be used to provide a notification to the user. Such a notification, in accordance with some particular embodiments, may include any of: a notification to the user that the aerosolizable material requires refilling; that the cartridge 2 requires replacing (where a cartridge 2/control unit 4 arrangement is employed); and/or a notification to the user that at least a portion of the aerosol provision system 1 has overheated.

To implement the above indications, as required, in accordance with some embodiments, the aerosol provision system 1 may further comprise any one or combination of an optic element (such as an LED), an acoustic element (such as a speaker) and a haptic feedback element (such as a vibrator). Appreciably, in some particular embodiments to those set out above, any such optical/acoustic/haptic feedback element(s) may be most conveniently located on the control unit 4 (where such a cartridge 2/control unit 4 arrangement is employed).

Appreciating the foregoing therefore, it is to be noted that the described operation for the control circuitry 18 to monitor the at least one temperature parameter P may be used in the context of any aerosol provision system 1, and not just those as shown in FIGS. 1-7 which employ the cartridge 2 and the control unit 4. In that respect however, where the aerosol provision system 1 does comprise the cartridge 2 and the control unit 4, in accordance with some of these embodiments, the reservoir 31, the aerosolizable material transport element 42 (wick), and the vaporizer 40 may be located in the cartridge 2. The control unit 4 may then comprise a cartridge receiving section that includes an interface arranged to cooperatively engage with the cartridge 2 so as to releasably couple the cartridge 2 to the control unit 4. In some embodiments thereof, the control unit 4 may then comprise the power supply 16 and the control circuitry 18 as described previously. Tying in with embodiments where the cartridge 2 and the control unit 4 is employed, in such embodiments where a sensor(s), such as the first temperature sensor(s) 202, is employed, in accordance with some embodiments thereof, the sensor(s) 200;202;202A;202B may be located in the cartridge, and be configured to be powered by the power supply 16 from the control unit 4.

In respect of any provided sensor(s) 200;202;202A;202B as well, in terms of how each sensor 200 may be configured to output a signal to the control circuitry 18, it will be appreciated that each such signal may be sent using either a wired or wireless connection between the control circuitry 18 and the respective sensor 200. In the particular non-limiting embodiments shown in FIG. 7, a wired connection is provided between each sensor 200 and the control circuitry 18, and which extends across the interface end 54 and corresponding receptacle 8 between the control unit 4 and the cartridge 2 via the contact electrodes 46.

Similarly, in terms of how any provided sensor(s) 200 may be powered, it will be appreciated that this may be achieved using either the power supply 16 (as shown in the embodiment of FIG. 7), or each sensor 200 comprising its own power source (not shown in the Figures).

For completeness as well, In respect of the wick/aerosolizable material transport element arrangement shown in FIG. 7, the vaporizer 40 is shown as extending around the wick/aerosolizable material transport element 42, though it will be appreciated that the teachings herein described may be applicable to other arrangements of wick 42 and/or vaporizer 40. In that respect for instance, it will be appreciated that the teachings herein may be applicable to other types of wick 42, such as where the wick 42 comprises a ceramic wick. In accordance with such embodiments, the vaporizer 40 from the wick 42 may comprise a conductive material located on an external surface of the wick 42. Such conductive material may appreciably take any required shape on the surface of the wick 42, e.g. a spiral pattern; a raster pattern; or a zig-zag pattern such to allow the vaporizer 40 to efficiently vaporise the aerosolizable material in the wick 42. As will be appreciated, the conductive material may be connected to the connection leads 41 which deliver power to the vaporizer 40.

For the sake of completeness therefore, whilst the vaporizer 40 in accordance with some embodiments may be configured to extend around the aerosolizable material transport element/wick 42, and/or be located on an external surface of the aerosolizable material transport element/wick 42, which provides for a convenient arrangement for efficiently vaporizing aerosolizable material from the aerosolizable material transport element 42, in accordance with other embodiments the vaporizer 40 may be configured to adopt other shapes and/or positions with respect to the aerosolizable material transport element/wick 42 in the aerosol provision system 1.

Thus, described herein are a number of configurations of aerosol provision system 1 whereby the control circuitry 18 from the aerosol provision system 1 may monitor at least one temperature parameter P relating to the temperature of the aerosolizable material transport element 42 over a predetermined period of time after the vaporizer 40 has been heated as part of a first heating operation H1, and generate a signal in the event the temperature parameter P decreases by a predetermined amount (such as less than a predetermined amount, in some particular embodiments) in a predetermined time interval T2 after the vaporizer has been heated, wherein the signal is indicative of a failure state of the aerosolizable material transport element 42.

In accordance with certain embodiments of the disclosure, a cartridge for an aerosol provision system may generally comprise a housing part having a mouthpiece end and an interface end, wherein the mouthpiece end includes an aerosol outlet for the cartridge and the interface end includes an interface for coupling the cartridge to a control unit. An air channel wall (which may be formed by various components of the cartridge) extends from an air inlet for the cartridge to the aerosol outlet via an aerosol generation region in the vicinity of a vaporizer. The cartridge has a reservoir within the housing part containing aerosolizable material for aerosolization. The reservoir is defined by a region within the housing part which is outside the air channel and an end of the reservoir at the interface end of the housing part is sealed by a resilient plug comprising a base part and an outer wall, wherein the outer wall of the resilient plug forms a seal with an inner surface of the housing part. Respective ends of an aerosolizable material transport element pass through opening in the air channel or into the reservoir so as to convey aerosolizable material from the reservoir to the vaporizer.

One aspect of some particular cartridge configurations in accordance with certain embodiments of the disclosure is the manner in which the resilient plug 44 provides a seal to the housing part 32. In particular, in accordance with some example implementations the outer wall 102 of the resilient plug 44 which seals to the inner surface of the housing part 32 to form the end of the aerosolizable material reservoir extends in direction parallel to the longitudinal axis of the cartridge to a position which is further from the interface end of the cartridge than the aerosolizable material transport element/vaporizer. That is to say, the ends of the aerosolizable material transport element extends into the aerosolizable material reservoir in a region which is surrounded by the outer sealing wall of the resilient plug. Not only does this help seal the reservoir against leakage, it allows the geometry of the reservoir in the region which supplies the aerosolizable material transport element with aerosolizable material to be governed by the geometry of the resilient plug. For example, the radial thickness of the reservoir in this region can readily be made smaller than the radial thickness in other longitudinal positions along the air channel, which can help trap aerosolizable material in the vicinity of the aerosolizable material transport element, thereby helping to reduce the risk of dry out for different orientations of the cartridge during use.

The outer wall of the resilient plug may, for example, contact the inner surface of the housing part at locations over a distance of at least 5 mm, 6 mm, 7 mm, 8 mm, 9 mm and 10 mm in a direction extending from the interface end to the mouthpiece end (i.e. parallel to the longitudinal axis). The outer wall of the resilient plug may be in contact with the inner surface of the housing over the majority of this distance, or the outer wall of the resilient plug may include a number of (e.g. four) circumferential ridges 140 to help improve sealing. The resilient plug may be slightly oversized relative to the opening in the housing part so that it is biased into slight compression. For example, for the implementation shown in FIG. 3B, the interior width of the housing part into which the resilient plug is inserted in the plane of this figure is around 17.5 mm, whereas the corresponding width of the resilient plug is around 18 mm, thereby placing the resilient plug into compression when inserted into the housing part. As can be most readily seen in FIGS. 5A to 5C, whereas the outer cross section of the cartridge housing part is symmetric under a 180° rotation, the resilient plug 44 does not have the same symmetry because it includes a flat 142 on one side to accommodate the air channel gap 76 provided by the double-walled section 74 of the housing part (i.e. the resilient plug is asymmetric in a plane perpendicular to a longitudinal axis of the cartridge to accommodate the double-walled section of the housing part).

In terms of the radial size/width of the reservoir in the annular region where the aerosolizable material transport element extends into the reservoir, a distance between the air channel wall and the outer wall of the resilient plug in this region may, for example, be in the range 3 mm to 8 mm. In the example cartridge discussed above which has a generally oval housing part and a generally circular air channel, it will be appreciated the thickness of the reservoir is different at different locations around the air channel. In this example the aerosolizable material transport element is arranged to extend into the reservoir in the region where it is widest in the axial direction, i.e. into the “lobes” of the oval reservoir around the air channel. The portions of the aerosolizable material transport element that extend into the reservoir may, for example, have a length, as measured from the interior of the air channel wall, in the range 2 mm to 8 mm, e.g. in the range 3 mm to 7 mm or in the range 4 mm to 6 mm. The specific geometry in this regard (and for other aspects of the configuration) may be chosen having regard to a desired rate of aerosolizable material transport, for example having regard to the capillary strength of the aerosolizable material transport element and the viscosity of the aerosolizable material, and may be established for a given cartridge design through modelling or empirical testing.

Another aspect of some particular cartridge configurations in accordance with certain embodiments of the disclosure is the manner in which the air channel is routed through the cartridge, and in particular from the air inlet to the vicinity of the vaporizer (the aerosol generation region). In particular, whereas in a conventional cartridges an air inlet is typically provided at the interface end of the cartridge, in accordance with certain embodiments of the disclosure, an air inlet for the cartridge is located in a side wall of the housing part at a position which is further from the interface end than at least a part of the resilient plug that seals an end of the reservoir. Thus, the air channel in the cartridge is initially routed from the air inlet towards the interface end and bypasses the resilient plug before changing direction and entering the aerosol generation chamber through the resilient plug. This can allow the outer surface of the cartridge at the interface end, where it is closest to the vaporizer, to be closed, thereby helping to reduce the risk of leakage from the cartridge, both in terms of aerosolizable material coming through the openings in the air channel which is not retained by the aerosolizable material transport element in the air channel (e.g. due to saturation/agitation) or aerosolizable material that has being vaporized but condensed back to aerosolizable material in the air channel during use. In some implementations, a distance from air inlet to the interface end of the housing part may be at least 5 mm, 6 mm, 7 mm, 8 mm, 9 mm or 10 mm.

In some example implementations an absorbent element, for example a portion of sponge material or a series of channels forming a capillary trap, may be provided between the air inlet and the aerosol generation chamber, for example in the region air channel formed between the base of the resilient plug and the end cap, to further help reduce the risk of leakage by absorbing aerosolizable material that forms in the air channel and so helping prevent the aerosolizable material travelling around the air channel through the air inlet or towards the aerosol outlet. In some example implementations the air channel from the air inlet to the aerosol outlet may have its smallest cross-sectional area where it passes through the hole 106 in the resilient plug. That is to say, the hole in the resilient plug may be primarily responsible for governing the overall resistance to draw for the electronic cigarette.

Another aspect of some particular cartridge configurations in accordance with certain embodiments of the disclosure is the manner in which the dividing wall element divides the air reservoir into two regions, namely a main region above the dividing wall (i.e. towards a mouthpiece end of the cartridge) and an aerosolizable-material-supply region below the dividing wall (i.e. on the same side of the dividing wall as where the aerosolizable material transport element extends from the vaporizer into the reservoir). The dividing wall includes openings to govern the flow of aerosolizable material on the main region to the aerosolizable material supply region. The dividing wall can help retain aerosolizable material in the aerosolizable material supply region of the reservoir, example when the electronic cigarette is tilted through various orientations, which can help avoid dry out. The dividing wall can also conveniently provide a mechanical stop for the resilient plug to abut/press against so as to help correctly locate the resilient plug during assembly and maintain the resilient plug in slight compression between the dividing wall and the end cap when the cartridge is assembled.

In the example discussed above, the dividing wall is formed as a separate element form the housing part, wherein an inner surface of the housing part includes one or more protrusions arranged to contact the side of the dividing wall facing the mouthpiece end of the cartridge to locate the dividing wall along a longitudinal axis of the cartridge, but in other examples the dividing wall may be integrally formed with the housing part.

In the example discussed above the dividing wall is in the form of an annular band around the air channel and comprises four fluid communication openings 150 located in respective quadrants of the band. However, more or fewer openings through the dividing wall may be provided in different implementations. Individual openings may, for example, have an area of between 4 mm² and 15 mm².

A combined area for the at least one openings as a fraction of the total area of the dividing wall exposed to aerosolizable material supply region of the reservoir region may be, for example, from 20% to 80%; 30% to 70% or 40% to 60%.

It will be appreciated that while the above description has focused on some specific cartridge configurations comprising a number of different features, cartridges in accordance with other embodiments of the disclosure may not include all these features. For example, in some implementations an air path generally of the kind discussed above, i.e. with an air inlet which is in a sidewall of the cartridge and closer to the mouthpiece end of the cartridge than the vaporizer, may be provided in a cartridge which does not include a resilient plug with an outer sealing wall which extends around the vaporizer and/or does not include a dividing wall element of the kind discussed above. Similarly, a cartridge which does include a resilient plug with an outer sealing wall which extends around the vaporizer may have an air inlet into the cartridge which is at the interface end of the cartridge, and not in a sidewall, and which may also not have a dividing wall element of the kind discussed above. Furthermore, a cartridge which does include a dividing wall element, might not include an air inlet located further from the interface end of the cartridge than the vaporizer and/or an extended outer sealing wall for a resilient plug as discussed above.

Thus, there has been described an aerosol provision system comprising an aerosolizable material transport element and a reservoir for aerosolizable material, wherein the aerosolizable material transport element comprises a vaporizer for vaporizing aerosolizable material in the aerosolizable material transport element; wherein the aerosol provision system comprises control circuitry which is configured to monitor at least one temperature parameter relating to the temperature of the aerosolizable material transport element over a predetermined period of time after the vaporizer has been heated as part of a first heating operation, and generate a signal in the event the temperature parameter decreases by a predetermined amount in a predetermined time interval after the vaporizer has been heated, wherein the signal is indicative of a failure state of the aerosolizable material transport element.

There has also been described a method of determining a failure state of an aerosolizable material transport element in an aerosol provision system comprising: control circuitry; a reservoir for aerosolizable material; and an aerosolizable material transport element, wherein the aerosolizable material transport element comprises a vaporizer for vaporizing aerosolizable material in the aerosolizable material transport element; wherein the method comprises: monitoring, using the control circuitry, at least one temperature parameter relating to the temperature of the aerosolizable material transport element over a predetermined period of time after the vaporizer has been heated as part of a first heating operation; determining, using the control circuitry, whether the temperature parameter decreases by a predetermined amount in a predetermined time interval after the vaporizer has been heated; and generating a signal in the event the temperature parameter decreases by the predetermined amount in a predetermined time interval after the vaporizer has been heated, wherein the signal is indicative of the failure state of the aerosolizable material transport element.

There has also been described an aerosol provision system 1 comprising an aerosolizable material transport element 42 and a reservoir 31 for aerosolizable material, wherein the aerosolizable material transport element 42 comprises a vaporizer 40 for vaporizing aerosolizable material in the aerosolizable material transport element 42. The aerosol provision system 1 comprises control circuitry 18 which is configured to monitor at least one temperature parameter P relating to the temperature of the aerosolizable material transport element 42 over a predetermined period of time after the vaporizer 40 has been heated as part of a first heating operation H1. The control circuitry 18 then generates a signal in the event the temperature parameter P decreases by a predetermined amount in a predetermined time interval T2 after the vaporizer 40 has been heated. This signal may be indicative of a failure state of the aerosolizable material transport element 42, such as the vaporizer 40 experiencing a dry-out state, such as from the aerosolizable material transport element 42 containing less than a predetermined amount of aerosolizable material.

While the above described embodiments have in some respects focused on some specific example aerosol provision systems, it will be appreciated the same principles can be applied for aerosol provision systems using other technologies. That is to say, the specific manner in which various aspects of the aerosol provision system function, for example in terms of the underlying form of the vaporizer or vaporizer technology used are not directly relevant to the principles underlying the examples described herein.

In that respect, it will also be appreciated that various modifications may be made to the embodiments of aerosol provision system described herein. For instance, although the vaporizer 40 has been described in a number of the above embodiments as being located in the cartridge, it will be appreciated that in some embodiments the vaporizer may be located in the control unit of the aerosol provision system.

In order to address various issues and advance the art, this disclosure shows by way of illustration various embodiments in which that which is claimed may be practiced. The advantages and features of the disclosure are of a representative sample of embodiments only, and are not exhaustive and/or exclusive. They are presented only to assist in understanding and to teach that which is claimed. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc., other than those specifically described herein, and it will thus be appreciated that features of the dependent claims may be combined with features of the independent claims in combinations other than those explicitly set out in the claims. The disclosure may include other inventions not presently claimed, but which may be claimed in future. In effect, any combination of feature(s) from one set of claims many be combined with any other individual feature(s) from any of the remaining set of claims.

1. An aerosol provision system comprising:
an aerosolizable material transport element;
a reservoir for aerosolizable material,
wherein the aerosolizable material transport element comprises a vaporizer for vaporizing the aerosolizable material in the aerosolizable material transport element; and
control circuitry which is configured to monitor at least one temperature parameter relating to a temperature of the aerosolizable material transport element over a predetermined period of time after the vaporizer has been heated as part of a first heating operation, and generate a signal if the temperature parameter decreases by a predetermined amount in a predetermined time interval after the vaporizer has been heated, wherein the signal is indicative of a failure state of the aerosolizable material transport element.

2. The aerosol provision system according to claim 1, wherein the failure state of the aerosolizable material transport element comprises at least one of the aerosolizable material transport element or the vaporizer experiencing a dry-out state.

3. The aerosol provision system according to claim 1, wherein the predetermined period of time ends before a start of a second heating operation of the vaporizer occurring after the first heating operation of the vaporizer.

4. The aerosol provision system according to claim 1, wherein at least one of the predetermined period of time or the predetermined time interval is no more than a second.

5. The aerosol provision system according to claim 1, wherein at least one of the predetermined period of time or the predetermined time interval is no more than 0.5 seconds.

6. The aerosol provision system according to claim 1, wherein the predetermined period of time is the same as the predetermined time interval.

7. The aerosol provision system according to claim 1, wherein the predetermined time interval is within, and less than, the predetermined period of time.

8. The aerosol provision system according to claim 1, wherein the predetermined time interval commences at least 0.05 seconds after an end of the first heating operation of the vaporizer.

9. The aerosol provision system according to claim 1, wherein at least one of the predetermined period of time or the predetermined time interval begins no more than 0.5 seconds after an end of the first heating operation.

10. The aerosol provision system according to claim 1, wherein at least one of the predetermined period of time or the predetermined time interval begins no more than 0.3 seconds after uan end of the first heating operation.

11. The aerosol provision system according to claim 1, wherein at least one of the predetermined period of time or the predetermined time interval begins no more than 0.1 seconds after an end of the first heating operation.

12. The aerosol provision system according to claim 1, wherein the aerosol provision system further comprises a first temperature sensor for outputting a first signal containing first data related to the temperature of the aerosolizable material transport element;
and wherein the control circuitry is further configured to receive the first signal from the first sensor, and process the first data from the first signal to determine the at least one temperature parameter.

13. The aerosol provision system according to claim 1, wherein the aerosol provision system further comprises a first temperature sensor comprising a resistor, wherein the resistor is configured to output an electrical resistance value related to the temperature of the aerosolizable material transport element;
and wherein the control circuitry is further configured to measure the electrical resistance value of the resistor, and process the electrical resistance value to determine the at least one temperature parameter.

14. The aerosol provision system according to claim 12, wherein the first temperature sensor is located in an electrical series circuit with the vaporizer.

15. The aerosol provision system according to claim 12, wherein the first temperature sensor is located on a surface of the aerosolizable material transport element.

16. The aerosol provision system according to claim 1, wherein the a least one temperature parameter is related to a temperature of the vaporizer.

17. The aerosol provision system according to claim 16, wherein the control circuitry is further configured to monitor an electrical resistance of the vaporizer to determine an electrical resistance value of the vaporizer, and process the electrical resistance value to determine the at least one temperature parameter.

18. The aerosol provision system according to claim 1, wherein the signal comprises a command to disable operation of the aerosol provision system.

19. The aerosol provision system according to claim 1, wherein the signal comprises a command to disable operation of the vaporizer.

20. The aerosol provision system according to claim 1, wherein the signal comprises at least one of: an optical signal, an acoustic signal, or a haptic signal.

21. The aerosol provision system according to claim 1, further comprising a cartridge and a control unit,
wherein the reservoir, the aerosolizable material transport element, and the vaporizer are located in the cartridge,
and wherein the control unit comprises a cartridge receiving section that includes an interface arranged to cooperatively engage with the cartridge so as to releasably couple the cartridge to the control unit, wherein the control unit further comprises a power supply and the control circuitry.

22. The aerosol provision system according to claim 21, wherein the aerosol provision system further comprises a first temperature sensor for outputting a first signal containing first data related to the temperature of the aerosolizable material transport element,
wherein the control circuitry is further configured to receive the first signal from the first sensor, and process the first data from the first signal to determine the at least one temperature parameter,
and wherein the first temperature sensor is located in the cartridge, and is configured to be powered by the power supply from the control unit.

23. A method of determining a failure state of an aerosolizable material transport element in an aerosol provision system comprising control circuitry; a reservoir for aerosolizable material; and an aerosolizable material transport element, wherein the aerosolizable material transport element comprises a vaporizer for vaporizing aerosolizable material in the aerosolizable material transport element, comprising:
monitoring, using the control circuitry, at least one temperature parameter relating to a temperature of the aerosolizable material transport element over a predetermined period of time after the vaporizer has been heated as part of a first heating operation;
determining, using the control circuitry, whether the temperature parameter decreases by a predetermined amount in a predetermined time interval after the vaporizer has been heated; and
generating a signal if the temperature parameter decreases by the predetermined amount in the predetermined time interval after the vaporizer has been heated, wherein the signal is indicative of a failure state of the aerosolizable material transport element.
